(19) United States
(12) Patent Application Publication
(10) Pub. No.: US 2026/0333339 A1
(43) Pub. Date: Oct. 22, 2026

(54) METHOD AND APPARATUS USED IN WIRELESS COMMUNICATION

(71) Applicant: Bunker Hill Technologies LLC, Allen, TX (US)

(72) Inventors: Jinfang ZHANG, Shanghai (CN); Xiaobo ZHANG, Shanghai (CN)

(21) Appl. No.: 19/101,157

(22) PCT Filed: Aug. 7, 2023
(86) PCT No.: PCT/CN2023/111368

§ 371 Date: Feb. 4, 2025

(30) Foreign Application Priority Data
Aug. 11, 2022 (CN) 202210963689.2

(51) Int. Cl. H04W 72/12; H04W 28/06

(52) U.S. Cl. CPC H04W 72/12; H04W 28/06

(57) ABSTRACT

A method and apparatus used in wireless communication. A first node receives a first PDCP SDU and a first timer is started in response thereto. When the first timer is in a running state, a first PDCP PDU is delivered to a first RLC entity for transmission, wherein the first PDCP PDU is a data unit after the first PDCP SDU is processed by a first PDCP entity. The first RLC entity is either a first candidate RLC entity or a second candidate RLC entity, depending on the value of the first timer. The first candidate RLC entity and the second candidate RLC entity are each associated with the first PDCP entity; a data unit comprised in the first candidate RLC entity is sent by means of a direct path; and a data unit comprised in the second candidate RLC entity is sent by means of a non-direct path.

### RELATED APPLICATIONS

This application is a National Stage under 35 USC 371 of and claims priority to International Application No. PCT/CN2023/111368, filed Aug. 7, 2023, which claims the priority benefit of CN Application No. 202210963689.2, filed Aug. 11, 2022.

### TECHNICAL FIELD

The present application relates to methods and devices in wireless communication systems, and more particularly to methods and devices supporting multipath transmission in wireless communication.

### BACKGROUND ART

In response to the rapid development of V2X (Vehicle-to-Everything, Internet of Vehicles) business, public safety (Public In order to develop new radio safety services and commercial applications and services, 3GPP (3rd Generation Partner Project) RAN (Radio Access Network) launched SI (Study Item) and WI (Work Item) in Release 1.7 for the “Study on NR (New Radio) Sidelink Relay”. Item, work item) standardization work, but due to time constraints, version 1.7 only supports limited features. To further support 5G (Fifth Generation) system enhancements, version 1.8 began the second phase of research on ProSe, including support for multi-path transmission. Multi-path transmission can include direct path transmission and indirect path transmission. In direct path transmission, there is only one hop transmission between the source node and the destination receiving node, and indirect path transmission includes multiple hops between the source node and the destination receiving node. Among them, relay, as a multi-hop transmission technology, can improve throughput, improve robustness, and increase coverage. The data of the source node reaches the destination receiving node through the forwarding of the relay node (RN). The source node and the destination receiving node are usually base station equipment and user equipment, or both can be user equipment; the relay node can be a network device or a user equipment. Taking the relay transmission in the LTE (Long Term Evolution) system as an example, the transmission from the user equipment to the relay node adopts the sidelink (SL) air interface technology, and the transmission from the relay node to the base station or enhanced node B (eNodeB, eNB) adopts the LTE air interface technology. The relay node is used for data forwarding between the UE (User Equipment) and the eNB.

### SUMMARY OF THE INVENTION

The inventors have found through research that for indirect paths, the network splits the total transmission delay into the transmission delay on each hop. In each hop transmission, if a data packet has not been successfully sent after reaching the maximum allowed transmission delay, the data packet is discarded. In multi-path transmission that supports both direct and indirect paths, a data packet timeout on an indirect path does not mean that the transmission on the direct path is also superseded. If the data packet is directly discarded, the service quality will be reduced. Therefore, how to select the transmission path between the direct path and the indirect path needs to be studied.

In view of the above problems, the present application discloses a solution that can effectively improve the success rate of data transmission. In the absence of conflict, the embodiments and features in the first node of the present application can be applied to the second node, and vice versa. In the absence of conflict, the embodiments and features in the embodiments of the present application can be arbitrarily combined with each other. Further, although the original intention of the present application is for the Uu air interface, the present application can also be used for the PC5 air interface. Further, although the original intention of the present application is for the terminal and base station scenario, the present application is also applicable to relays and base stations to achieve similar technical effects in terminal and base station scenarios. In addition, the use of a unified solution for different scenarios (including but not limited to V2X scenarios and communication scenarios between terminals and base stations) also helps to reduce hardware complexity and cost. In particular, the interpretation of terms (Terminology), nouns, functions, and variables in this application (if not otherwise specified) can refer to the definitions in the 3GPP specification protocols TS36 series, TS38 series, and TS37 series.

The present application discloses a method in a first node used for wireless communication, characterized by comprising:
receiving a first PDCP SDU;

In response to receiving the first PDCP SDU, starting a first timer;

When the first timer is in a running state, delivering a first PDCP PDU to a first RLC entity for sending;

Among them, the first PDCP PDU is a data unit after the first PDCP SDU is processed by the first PDCP entity; the first RLC entity is one of the first candidate RLC entity and the second candidate RLC entity, and whether the first RLC entity is the first candidate RLC entity or the second candidate RLC entity is related to the value of the first timer; the first candidate RLC entity and the second candidate RLC entity are respectively associated with the first PDCP entity; the data unit included in the first candidate RLC entity is sent through a direct path; the data unit included in the second candidate RLC entity is sent through a non-direct path.

As an embodiment, the present application is applicable to dual connectivity transmission.

As an embodiment, the present application is applicable to multi-path transmission.

As an embodiment, the present application is applicable to a scenario in which multipath transmission includes a direct path and an indirect path.

[symbol] is forwarded through UE-to-Network (U 2 N) relay.

As an embodiment, the non-direct path in the present application is forwarded through layer (Layer) 2 U 2 N relay.

As an embodiment, the non-direct path in the present application is forwarded via layer 2 U 2 U (UE-to-UE, user to user) relay.

As an embodiment, the present application is applicable to PDCP (Packet Data Convergence Protocol) recovery.

As an embodiment, the above method can increase the data transmission rate and enhance the robustness of data transmission by sending through a non-direct path.

As an embodiment, the above method can reduce transmission delay by sending through a direct path.

As an embodiment, the above method determines the first RLC (Radio Link Control) entity through the value of the first timer to simultaneously increase the transmission rate and avoid the transmission delay introduced by relay forwarding, which causes the first PDCP The SDU (Service Data Unit) has expired when it reaches the destination receiver, causing service quality to deteriorate.

As an embodiment, the above method is backward compatible, which helps to reduce hardware complexity and cost.

As an embodiment, the entity in the present application is a module.

As an embodiment, an entity in the present application is a module that completes a set of functions.

As an embodiment, the entity in the present application is a hardware module that implements a set of functions.

As an embodiment, the entity in the present application is a software module that implements a set of functions.

As an embodiment, the relay node and the relay UE in the present application may be interchangeable.

According to one aspect of the present application, it includes:

When the value of the first timer is greater than a first threshold, the first RLC entity is the first candidate RLC entity.

As an embodiment, the above method can reduce transmission delay and avoid packet loss due to exceeding packet delay budget (PDB).

According to one aspect of the present application, it includes:

When the value of the first timer is less than the first threshold, whether the first RLC entity is the first candidate RLC entity or the second candidate RLC entity is related to a reference data amount;

The reference data amount is the total amount of the PDCP data in the first PDCP entity and the RLC data amounts waiting for initial transmission in the first candidate RLC entity and the second candidate RLC entity.

As an embodiment, the above method is compatible with split bearer bearer).

As an embodiment, the above method can improve the transmission rate.

As an embodiment, the above method supports services with large bandwidth requirements.

According to one aspect of the present application, it includes:
delivering the first PDCP PDU to the first candidate RLC entity for sending;

The value of the first timer is greater than the first threshold and the first timer has not expired; the first PDCP entity has not received an indication of successful sending of the first PDCP PDU from the second candidate RLC entity; and the first RLC entity is the second candidate RLC entity.

As an embodiment, the above method can improve data transmission robustness through retransmission by the first candidate RLC entity.

According to one aspect of the present application, it includes:
sending a first indication, where the first indication is used to indicate to the first RLC entity to discard the first PDCP PDU; discarding the first RLC SDU when neither the first RLC SDU nor a segment of the first RLC SDU has been delivered to a lower layer;

The first RLC SDU is the first PDCP PDU.

As an embodiment, the above method discards the first PDCP PDU (Protocol Data Unit) can save air interface resources.

According to one aspect of the present application, it includes:

The direct path includes only one air interface, and the indirect path includes at least two air interfaces.

According to one aspect of the present application, it includes:
receiving a first message indicating a first expiration value and the first threshold;

The first expiration value is used to determine the expiration of the first timer; the difference between the first expiration value and the first threshold is used to determine the maximum transmission delay of the first PDCP PDU forwarded through the node where the opposite RLC entity of the second candidate RLC entity is located.

As an embodiment, the above method can achieve consistent transmission delay performance when transmitting on each path of multiple paths.

The present application discloses a first node used for wireless communication, characterized in that it includes:

A first transceiver receives a first PDCP SDU; starts a first timer as a response to receiving the first PDCP SDU; and delivers the first PDCP PDU to a first RLC entity for transmission when the first timer is in a running state;

Among them, the first PDCP PDU is a data unit after the first PDCP SDU is processed by the first PDCP entity; the first RLC entity is one of the first candidate RLC entity and the second candidate RLC entity, and whether the first RLC entity is the first candidate RLC entity or the second candidate RLC entity is related to the value of the first timer; the first candidate RLC entity and the second candidate RLC entity are respectively associated with the first PDCP entity; the data unit included in the first candidate RLC entity is sent through a direct path; the data unit included in the second candidate RLC entity is sent through a non-direct path.

According to one aspect of the present application, it includes:

When the value of the first timer is greater than a first threshold, the first RLC entity is the first candidate RLC entity.

According to one aspect of the present application, it includes:

When the value of the first timer is less than the first threshold, whether the first RLC entity is the first candidate RLC entity or the second candidate RLC entity is related to a reference data amount;

The reference data amount is the total amount of the PDCP data in the first PDCP entity and the RLC data amounts waiting for initial transmission in the first candidate RLC entity and the second candidate RLC entity.

According to one aspect of the present application, it includes:

The first transceiver delivers the first PDCP PDU to the first candidate RLC entity for transmission;

The value of the first timer is greater than the first threshold and the first timer has not expired; the first PDCP entity has not received an indication of successful sending of the first PDCP PDU from the second candidate RLC entity; and the first RLC entity is the second candidate RLC entity.

According to one aspect of the present application, it includes:

The first transceiver sends a first indication, where the first indication is used to indicate to the first RLC entity to discard the first PDCP PDU; when the first RLC SDU or the segment of the first RLC SDU is not delivered to a lower layer, discard the first RLC SDU;

The first RLC SDU is the first PDCP PDU.

According to one aspect of the present application, it includes:

The direct path includes only one air interface, and the indirect path includes at least two air interfaces.

According to one aspect of the present application, it includes:

The first transceiver receives a first message, wherein the first message indicates a first expiration value and the first threshold; wherein the first expiration value is used to determine the expiration of the first timer; and the difference between the first expiration value and the first threshold is used to determine the maximum transmission delay of the first PDCP PDU forwarded through the node where the opposite RLC entity of the second candidate RLC entity is located.

### BRIEF DESCRIPTION OF THE DRAWINGS

Other features, objects and advantages of the present application will become more apparent by reading the detailed description of non-limiting embodiments made with reference to the following drawings:

FIG. 1 illustrates a transmission flow chart of a first node according to an embodiment of the present application;

FIG. 2 illustrates a schematic diagram of a network architecture according to an embodiment of the present application;

FIG. 3 illustrates a schematic diagram of a wireless protocol architecture of a user plane and a control plane according to an embodiment of the present application;

FIG. 4 illustrates a schematic diagram of hardware modules of a communication device according to an embodiment of the present application;

FIG. 5 illustrates a signal transmission flow chart according to an embodiment of the present application;

FIG. 6 illustrates another signal transmission flow chart according to an embodiment of the present application;

FIG. 7 illustrates a signal processing flow chart according to an embodiment of the present application;

FIG. 8 illustrates another signal processing flow chart according to an embodiment of the present application;

FIG. 9 illustrates a schematic diagram of a wireless protocol architecture for relay transmission according to an embodiment of the present application;

FIG. 10 illustrates a schematic diagram of a first PDCP entity, a first candidate RLC entity, and a second candidate RLC entity according to an embodiment of the present application;

FIG. 11 illustrates a schematic diagram of a topological structure according to an embodiment of the present application;

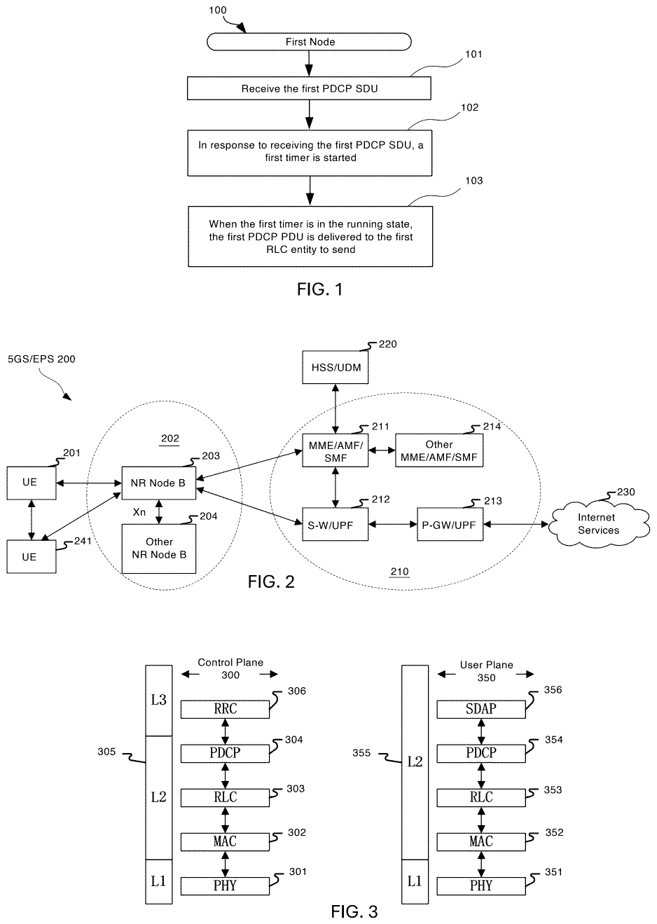

FIG. 1-2 illustrates a wireless signal transmission flow chart according to an embodiment of the present application;

FIG. 1 to FIG. 3 illustrate a structural block diagram of a processing device in a first node according to an embodiment of the present application.

### DETAILED DESCRIPTION

The technical solution of the present application will be further described in detail below in conjunction with the accompanying drawings. It should be noted that, in the absence of conflict, the embodiments of the present application and the features in the embodiments can be arbitrarily combined with each other.

### Example 1

Embodiment 1 illustrates a transmission flow chart of a first node according to an embodiment of the present application, as shown in FIG. 1.

In embodiment 1, the first node 100 receives a first PDCP SDU in step 101; in step 102, as a response to receiving the first PDCP SDU, starts a first timer; in step 103, when the first timer is in a running state, delivers the first PDCP PDU to the first RLC entity for sending; wherein, the first PDCP PDU is a data unit after the first PDCP SDU is processed by the first PDCP entity; the first RLC entity is one of the first candidate RLC entity and the second candidate RLC entity, and whether the first RLC entity is the first candidate RLC entity or the second candidate RLC entity is related to the value of the first timer; the first candidate RLC entity and the second candidate RLC entity are respectively associated with the first PDCP entity; the data unit included in the first candidate RLC entity is sent via a direct path; the data unit included in the second candidate RLC entity is sent via a non-direct path.

As an embodiment, receiving a first PDCP SDU.

As an embodiment, the first PDCP The SDU comes from a higher layer of the first node.

As an embodiment, the first PDCP entity receives the first PDCP from a higher layer of the first node. SDU.

As an embodiment, the higher layer is a SDAP sublayer; wherein the first PDCP SDU belongs to data radio bearer (data radio bearer, DRB).

As an embodiment, the higher layer is an RRC sublayer; wherein the first PDCP SDU belongs to the signaling radio bearer bearer, SRB).

As an embodiment, as receiving the first PDCP In response to the SDU, the first timer is started.

As an embodiment, the first timer is maintained at the PDCP sublayer of the first node.

As an embodiment, the first timer is a discardTimer (discard timer).

As an embodiment, after the first timer starts, the first timer is in a running state.

As an embodiment, when the first timer is in a running state, the first PDCP PDU is delivered to the first RLC entity for sending.

As an embodiment, when the first timer expires, the first PDCP SDU and the first PDCP PDU.

As a sub-embodiment of the above embodiment, if the first PDCP PDU has been delivered to the lower layer layers), discarding is directed to the lower layers.

As an embodiment, the first PDCP PDU is a PDCP data (data) PDU.

As an embodiment, when the first timer is in a running state, the first PDCP entity delivers the first PDCP PDU to the first RLC entity through an inter-layer interface for transmission.

As an embodiment, the first PDCP PDU is a data unit after the first PDCP SDU is processed by the first PDCP entity.

As an embodiment, the processing of the first PDCP SDU in the first PDCP entity includes ROHC (Robust Header Compression).

As an embodiment, the processing of the first PDCP SDU in the first PDCP entity includes ciphering.

As an embodiment, the processing of the first PDCP SDU in the first PDCP entity includes integrity protection and authentication (Integrity protection and verification).

As an embodiment, the first PDCP The PDU includes the first PDCP The processed bits of the SDU.

As an embodiment, the first PDCP The PDU consists of the first PDCP The SDU consists of processed bits and a PDCP header.

As an embodiment, the PDCP header includes the first PDCP The sequence number of the PDU number, SN).

As an embodiment, the first PDCP entity is a transmitting PDCP entity (transmitting PDCP entity).

As an embodiment, the first RLC entity is one of a first candidate RLC entity and a second candidate RLC entity.

As an embodiment, the first candidate RLC entity and the second candidate RLC entity are respectively associated with the first PDCP entity.

As an embodiment, the phrases first candidate RLC entity and the second candidate RLC entity are respectively associated with the first PDCP entity include: the first candidate RLC entity and the second candidate RLC entity are both used to transmit data units from the first PDCP entity.

As an embodiment, the first PDCP entity is maintained at the first node.

As an embodiment, the first PDCP entity is located in the PDCP sublayer.

As an embodiment, the first candidate RLC entity and the second candidate RLC entity are maintained at the first node respectively.

As an embodiment, the first candidate RLC entity and the second candidate RLC entity are respectively located in the RLC sublayer.

As an embodiment, the first candidate RLC entity and the second candidate RLC entity are in an activated state.

As an embodiment, the data unit included in the first candidate RLC entity is sent via a direct connection path.

As an embodiment, the phrase that the data unit included in the first candidate RLC entity is sent through a direct path includes: the node where the peer RLC entity of the first candidate RLC entity is located is the first PDCP The intended recipient of the SDU.

As an embodiment, the data unit included in the second candidate RLC entity is sent via a non-direct path.

As an embodiment, the phrase that the data unit included in the second candidate RLC entity is sent via a non-direct path includes: the node where the peer RLC entity of the second candidate RLC entity is located is not the first PDCP The intended recipient of the SDU.

As an embodiment, the phrase that the data unit included in the second candidate RLC entity is sent via a non-direct path includes: the node where the peer RLC entity of the second candidate RLC entity is located is the first PDCP PDU relay node.

As an embodiment, the information element for configuring the first candidate RLC entity is RLC-BearerConfig (RLC bearer configuration).

As an embodiment, the first candidate RLC entity is identified by a logical channel identifier (LCID).

As an embodiment, the data processed by the first candidate RLC entity is transmitted through a PUSCH (Physical Up link Shared Channel) channel at the physical layer.

As an embodiment, the information element for configuring the second candidate RLC entity is SL-RLC-ChannelConfig (secondary link RLC channel configuration).

As an embodiment, the second candidate RLC entity is identified by an RLC channel (RLC channel Identity).

As an embodiment, the data processed by the second candidate RLC entity is transmitted through a PSSCH (Physical Sidelink Shared CHannel) channel at the physical layer.

As an embodiment, the logical channel identifier or the RLC channel identifier is configured by a base station of a service cell of the first node.

As an embodiment, a logical channel identifier or an RLC channel identifier is used to identify an RLC entity on the network side.

As an embodiment, the first candidate RLC entity is used for transmission of the Uu air interface.

As an embodiment, the second candidate RLC entity is used for transmission of PC5 air interface.

As a sub-embodiment of the above embodiment, the second candidate RLC entity is associated with a logical channel in the PC5 air interface, and the logical channel is allocated by the first node itself.

As an embodiment, whether the first RLC entity is the first candidate RLC entity or the second candidate RLC entity is related to the value of the first timer.

As an embodiment, the value of the first timer is used to determine whether the first RLC entity is the first candidate RLC entity or the second candidate RLC entity.

The above method is applied to the first PDCP The PDU is first delivered to the RLC entity.

The above method is applied to the first PDCP Each delivery of a PDU when it is delivered multiple times to an RLC entity.

As an embodiment, the phrase whether the first RLC entity is the first candidate RLC entity or the second candidate RLC entity is related to the value of the first timer and includes: when the first PDCP PDU is delivered to the first RLC entity for the first time, the first RLC entity is the second candidate RLC entity and the value of the first timer is less than a first threshold; when the first PDCP PDU is delivered to the first RLC entity for the first time, the first RLC entity is the first candidate RLC entity and the value of the first timer is not less than the first threshold.

As an embodiment, the phrase whether the first RLC entity is the first candidate RLC entity or the second candidate RLC entity is related to the value of the first timer and includes: when the first PDCP PDU is delivered to the first RLC entity for the first time, the first RLC entity is the second candidate RLC entity and the value of the first timer is not greater than a first threshold; when the first PDCP PDU is delivered to the first RLC entity for the first time, the first RLC entity is the first candidate RLC entity and the value of the first timer is greater than the first threshold.

As a sub-embodiment of the above two embodiments, the second candidate RLC entity belongs to a primary path.

As an embodiment, the phrase whether the first RLC entity is the first candidate RLC entity or the second candidate RLC entity is related to the value of the first timer and includes: when the first PDCP PDU is delivered to the first RLC entity for the first time, the first RLC entity is one of the first candidate RLC entity or the second candidate RLC entity and the value of the first timer is less than a first threshold; when the first PDCP PDU is delivered to the first RLC entity for the first time, the first RLC entity is the first candidate RLC entity and the value of the first timer is not less than the first threshold.

As an embodiment, the phrase whether the first RLC entity is the first candidate RLC entity or the second candidate RLC entity is related to the value of the first timer and includes: when the first PDCP PDU is delivered to the first RLC entity for the first time, the first RLC entity is one of the first candidate RLC entity or the second candidate RLC entity and the value of the first timer is not greater than a first threshold; when the first PDCP PDU is delivered to the first RLC entity for the first time, the first RLC entity is the first candidate RLC entity and the value of the first timer is greater than the first threshold.

As a sub-embodiment of the above two embodiments, whether the first RLC entity is the first candidate RLC entity or the second candidate RLC entity is implemented by the first node.

As an embodiment, the phrase whether the first RLC entity is the first candidate RLC entity or the second candidate RLC entity is related to the value of the first timer and includes: when the first PDCP PDU is delivered to the first RLC entity for the first time, the first RLC entity is the second candidate RLC entity and the value of the first timer is less than a first threshold; when the first PDCP PDU is delivered to the first RLC entity again, the first RLC entity is the first candidate RLC entity and the value of the first timer is not less than the first threshold.

As an embodiment, the phrase whether the first RLC entity is the first candidate RLC entity or the second candidate RLC entity is related to the value of the first timer and includes: when the first PDCP PDU is delivered to the first RLC entity for the first time, the first RLC entity is the second candidate RLC entity and the value of the first timer is not greater than a first threshold; when the first PDCP PDU is delivered to the first RLC entity again, the first RLC entity is the first candidate RLC entity and the value of the first timer is greater than the first threshold.

As a sub-embodiment of the above two embodiments, the second candidate RLC entity belongs to the primary path.

As an embodiment, a first transceiver receives a first PDCP SDU; as a response to receiving the first PDCP SDU, starts a first timer and a second timer; when the first timer is in a running state, delivers the first PDCP PDU to a first RLC entity for transmission; wherein the first PDCP PDU is a data unit after the first PDCP SDU is processed by the first PDCP entity; the first RLC entity is one of a first candidate RLC entity and a second candidate RLC entity, and whether the first RLC entity is the first candidate RLC entity or the second candidate RLC entity is related to the running state of the first timer and the running state of the second timer; the first candidate RLC entity and the second candidate RLC entity are respectively associated with the first PDCP entity; the data unit included in the first candidate RLC entity is sent via a direct path; the data unit included in the second candidate RLC entity is sent via a non-direct path.

As an embodiment, the running state of the first timer and the running state of the second timer are used to determine whether the first RLC entity is the first candidate RLC entity or the second candidate RLC entity.

As an embodiment, when the first timer is in a running state and the second timer expires, the first RLC entity is the first candidate RLC entity.

As an embodiment, when the first timer is in a running state and the second timer is in a running state, the first RLC entity is the second candidate RLC entity.

As a sub-embodiment of the above embodiment, the second candidate RLC entity belongs to a primary path.

As an embodiment, when the first timer is in a running state and the second timer is in a running state, the first RLC entity is the first candidate RLC entity or the second candidate RLC entity.

As a sub-embodiment of the above embodiment, whether the first RLC entity is the first candidate RLC entity or the second candidate RLC entity is implemented by the first node.

As an embodiment, the expiration value of the first timer is greater than the expiration value of the second timer.

As an embodiment, the expiration value of the first timer indicates a peer-to-peer data packet delay budget on an air interface.

As an embodiment, the expiration value of the second timer indicates a point-to-point data packet delay budget on an air interface.

As an embodiment, the expiration value of the second timer indicates a data packet delay budget on an air interface.

As an embodiment, the expiration value of the second timer indicates a data packet delay budget on a first air interface, wherein the path where the second candidate RLC entity is located is a non-direct path, and the non-direct path includes at least 2 air interfaces.

### Example 2

Embodiment 2 illustrates a schematic diagram of a network architecture according to an embodiment of the present application, as shown in FIG. 2. FIG. 2 illustrates a diagram of a network architecture 200 of a NR 5G, LTE (Long-Term Evolution) and LTE-A (Long-Term Evolution Advanced) system. The NR 5G, LTE or LTE-A network architecture 200 may be referred to as 5GS (5G System)/EPS (Evolved Packet System) 200 or some other suitable term. 5GS/EPS 200 may include one or more UE (User Equipment) 201, NG-RAN (Next Generation Radio Access Network) 202, 5GC (5G Core Network)/EPC (Evolved Packet Core) 210, HSS (Home Subscriber Server)/UDM (Unified Data Management) 220 and Internet Service 230. 5GS/EPS can be interconnected with other access networks, but these entities/interfaces are not shown for simplicity. As shown, 5GS/EPS provides packet switching services, but technicians in the field will easily understand that the various concepts presented throughout this application can be extended to networks that provide circuit switching services or other cellular networks. NG-RAN includes NR Node B (gNB) 203 and other gNBs 204. gNB 203 provides user and control plane protocol terminations toward UE 201. gNB 203 can be connected to other gNBs 204 via an Xn interface (e.g., a backhaul link). The XnAP protocol of the Xn interface is used to transmit control plane messages of the wireless network, and the user plane protocol of the Xn interface is used to transmit user plane data. gNB 203 may also be referred to as a base station, a base transceiver station, a radio base station, a radio transceiver, a transceiver function, a Basic Service Set (BSS), an Extended Service Set (ESS), a TRP (Transmission Reception Point) or some other suitable term. In a NTN (Non Terrestrial Network) network, gNB 203 may be a satellite, an aircraft, or a ground base station relayed by a satellite. gNB 203 provides an access point to 5GC/EPC 210 for UE 201. Examples of UE 201 include cellular phones, smart phones, Session Initiation Protocol (SIP) phones, laptop computers, personal digital assistants (PDAs), satellite radios, global positioning systems, multimedia devices, video devices, digital audio players (e.g., MP3 players), cameras, game consoles, drones, aircraft, narrowband Internet of Things devices, machine type communication devices, land vehicles, cars, vehicle-mounted devices, vehicle-mounted communication units, wearable devices, or any other similar functional devices. Those skilled in the art may also refer to UE 201 as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term. gNB 203 is connected to 5GC/EPC 210 via S1/NG interface. 5GC/EPC 210 includes MME (Mobility Management Entity)/AMF (Authentication Management Field)/SMF (Session Management Function) 211, other MME/AMF/SMF 214, S-GW (Service Gateway)/UPF (User Plane Function) 212, and P-GW (Packet Data Network Gateway)/UPF 213. MME/AMF/SMF 211 is the control node that handles signaling between UE 201 and 5GC/EPC 210. In general, MME/AMF/SMF 211 provides bearer and connection management. All user IP (Internet Protocol) packets are transmitted through S-GW/UPF 212, which itself is connected to P-GW/UPF 213. P-GW provides UE IP address allocation and other functions. P-GW/UPF 213 is connected to Internet service 230. Internet service 230 includes operator-corresponding Internet protocol services, which may specifically include Internet, Intranet, IMS (IP Multimedia Subsystem) and PS (Packet Switching) streaming services.

As an embodiment, the UE 201 corresponds to the first node in this application.

As an embodiment, the gNB 203 corresponds to the second node in this application.

As an embodiment, the UE 241 corresponds to the third node in this application.

As an embodiment, the UE 201 is a user equipment.

As an embodiment, the UE 241 is a relay node.

As an embodiment, the UE 241 is a layer 2 relay node.

As an embodiment, the UE 241 is a layer 2 U 2 N relay UE.

As an embodiment, the UE 241 is a layer 2 U 2 U relay UE.

As an embodiment, the gNB 203 is a macro cell (Macro Cell) base station.

As an embodiment, the gNB 203 is a micro cell (Micro Cell) base station.

As an embodiment, the gNB 203 is a pico cell. Cell) base station.

As an embodiment, the gNB 203 is a home base station (Femtocell).

As an embodiment, the gNB 203 is a base station device that supports large delay difference.

As an embodiment, the gNB 203 is a flying platform device.

As an embodiment, the gNB 203 is a satellite device.

As an embodiment, the gNB 203 is a base station device that supports large delay difference.

As an embodiment, the gNB 203 is a testing device (e.g., a transceiver that simulates some functions of a base station, a signaling tester).

As an embodiment, the wireless link from the UE 201 to the gNB 203 is an uplink, and the uplink is used to perform uplink transmission.

As an embodiment, the wireless link from the UE 241 to the gNB 203 is an uplink, and the uplink is used to perform uplink transmission.

As an embodiment, the wireless link from the gNB 203 to the UE 201 is a downlink, and the downlink is used to perform downlink transmission.

As an embodiment, the wireless link from the gNB 203 to the UE 241 is a downlink, and the downlink is used to perform downlink transmission.

As an embodiment, the wireless link between the UE 201 and the UE 241 is a secondary link, and the secondary link is used to perform secondary link transmission.

As an embodiment, the UE 201 and the gNB 203 are connected via a Uu air interface.

As an embodiment, the UE 241 and the gNB 203 are connected via a Uu air interface.

As an embodiment, the UE 201 and the UE 241 are connected via a PC5 air interface.

### Example 3

Embodiment 3 illustrates a schematic diagram of a radio protocol architecture for a user plane and a control plane according to an embodiment of the present application, as shown in FIG. 3. FIG. 3 is a schematic diagram illustrating an embodiment of a radio protocol architecture for a user plane 350 and a control plane 300, and FIG. 3 shows the radio protocol architecture of the control plane 300 of a UE and a gNB in three layers: layer 1, layer 2, and layer 3. Layer 1 (L1 layer) is the lowest layer and implements various PHY (physical layer) signal processing functions. The L1 layer will be referred to as PHY 301 herein. Layer 2 (L2 layer) 305 is above PHY 301 and is responsible for the link between the UE and the gNB through PHY 301. The L2 layer 305 includes a MAC (Medium Access Control) sublayer 302, an RLC (Radio Link Control) sublayer 303, and a PDCP (Packet Data Convergence Protocol) sublayer 304, which terminate at the gNB on the network side. The PDCP sublayer 304 provides data encryption and integrity protection. The PDCP sublayer 304 also provides inter-zone mobility support for UEs between gNBs. The RLC sublayer 303 provides segmentation and reassembly of data packets, and uses ARQ The RLC sublayer 303 also provides duplicate packet detection and protocol error detection. The MAC sublayer 302 provides mapping between logical channels and transport channels and multiplexing of logical channels. The MAC sublayer 302 is also responsible for allocating various radio resources (e.g., resource blocks) in a cell between UEs. The MAC sublayer 302 is also responsible for HARQ (Hybrid Automatic Repeat Request) operations. The RRC (Radio Control Module) in layer 3 (L3) of the control plane 300 Resource The control (radio resource control) sublayer 306 is responsible for obtaining radio resources (i.e., radio bearers) and configuring lower layers using RRC signaling between the gNB and the UE. The radio protocol architecture of the user plane 350 includes layer 1 (L1 layer) and layer 2 (L2layer). The radio protocol architecture in the user plane 350 is substantially the same as the corresponding layers and sublayers in the control plane 300 for the physical layer 351, the PDCP sublayer 354 in the L2 layer 355, the RLC sublayer 353 in the L2 layer 355, and the MAC sublayer 352 in the L2 layer 355, but the PDCP sublayer 354 also provides header compression for upper layer data packets to reduce radio transmission overhead. The L2 layer 355 in the user plane 350 also includes a SDAP (Service Data Adaptation Protocol) sublayer 356, which is responsible for mapping between QoS flows and data radio bearers (DRBs) to support the diversity of services. The wireless protocol architecture of the UE in the user plane 350 may include, at the L2 layer, a SD AP sublayer 356, a PDCP sublayer 354, a portion of or all of the protocol sublayers of the RLC sublayer 353 and the MAC sublayer 352. Although not shown, the UE may also have several upper layers above the L2 layer 355, including a network layer (e.g., an IP layer) terminated at the P-GW on the network side and an application layer terminated at the other end of the connection (e.g., a remote UE, a server, etc.).

As an embodiment, the PDCP 304 sends data to the RLC 303 or receives data from the RLC 303 through an RLC channel.

As an embodiment, the PDCP 354 sends data to the RLC 353 or receives data from the RLC 353 through an RLC channel.

As an embodiment, the RLC 303 sends data to the MAC 302 or receives data from the MAC 302 through a logical channel.

As an embodiment, the RLC 353 sends data to or receives data from the MAC 352 through a logical channel.

As an embodiment, the MAC 302 sends data to the PHY 301 or receives data from the PHY 301 through a transmission channel.

As an embodiment, the MAC 352 sends data to or receives data from the PHY 351 through a transmission channel.

As an embodiment, the first transceiver is used for inter-layer communication within the first node.

As an embodiment, the inter-layer communication includes communication between two adjacent layers.

As an embodiment, the inter-layer communication includes communication between two non-adjacent layers.

As an embodiment, the inter-layer communication includes inter-layer communication between the first PDCP entity and the first RLC entity.

As an embodiment, the inter-layer communication includes communication between the higher layer protocol entity and the first PDCP entity.

As an embodiment, the inter-layer communication includes communication between the first RLC entity and a lower-level protocol entity.

As an embodiment, the first transceiver is used by the PDCP 304 to send to the RLC 303.

As an embodiment, the first transceiver is used by the PDCP 304 to receive from the RLC 303.

As an embodiment, the first transceiver is used by the PDCP 354 to send to the RLC 353.

As an embodiment, the first transceiver is used by the PDCP 354 to receive from the RLC 353.

As an embodiment, the first transceiver is used by the RLC 303 to send to the PDCP 304.

As an embodiment, the first transceiver is used by the RLC 303 to receive from the PDCP 304.

As an embodiment, the first transceiver is used by the RLC 353 to send to the PDCP 354.

As an embodiment, the first transceiver is used by the RLC 353 to receive from the PDCP 354.

As an embodiment, the first transceiver includes inter-layer transceiver primitives.

As an embodiment, the first transceiver includes a set of instructions for completing the transceiver function.

As an embodiment, entities of multiple sub-layers of the control plane in FIG. 3 form a SRB (Signaling Radio Bearer) in the vertical direction.

As an embodiment, entities of multiple sub-layers of the user plane in FIG. 3 form a DRB (Data Radio Bearer) in the vertical direction.

As an embodiment, entities of multiple sub-layers of the user plane in FIG. 3 form an MRB (MBS Radio Bearer) in the vertical direction.

As an embodiment, the wireless protocol architecture in FIG. 3 is applicable to the first node in the present application.

As an embodiment, the wireless protocol architecture in FIG. 3 is applicable to the second node in the present application.

As an embodiment, the wireless protocol architecture in FIG. 3 is applicable to the third node in the present application.

As an embodiment, the first PDCP in this application The SDU is generated in the RRC 306.

As an embodiment, the first PDCP in this application The SDU is generated in the SDAP 356.

As an embodiment, the first PDCP in this application The PDU is generated in the PDCP 304.

As an embodiment, the first PDCP in this application The PDU is generated in the PDCP 354.

As an embodiment, when the first PDCP When the PDU is generated in the PDCP 304, the first PDCP entity is located in the PDCP 304, and the first candidate RLC entity and the second candidate RLC entity are located in the RLC 303.

As an embodiment, when the first PDCP when the PDU is generated in the PDCP 354, the first PDCP entity is located in the PDCP 354, and the first candidate RLC entity and the second candidate RLC entity are located in the RLC 353.

As an embodiment, the data packet on the interface between the PDCP sublayer and the RLC sublayer is called a PDCP PDU in the PDCP sublayer and an RLC SDU in the RLC sublayer, that is, the PDCP sublayer transmits the PDCP PDU to the RLC sublayer, and the RLC sublayer receives the RLC SDU from the PDCP sublayer. The RLC sublayer delivers the RLC SDU to the PDCP sublayer, and the PDCP sublayer receives the PDCP PDU from the RLC sublayer.

As an embodiment, the first PDCP PDU and the first RLC SDU may be interchanged.

As an embodiment, the L2 layer 305 or 355 belongs to a higher layer.

As an embodiment, the RRC sublayer 306 in the L3 layer belongs to a higher layer.

### Example 4

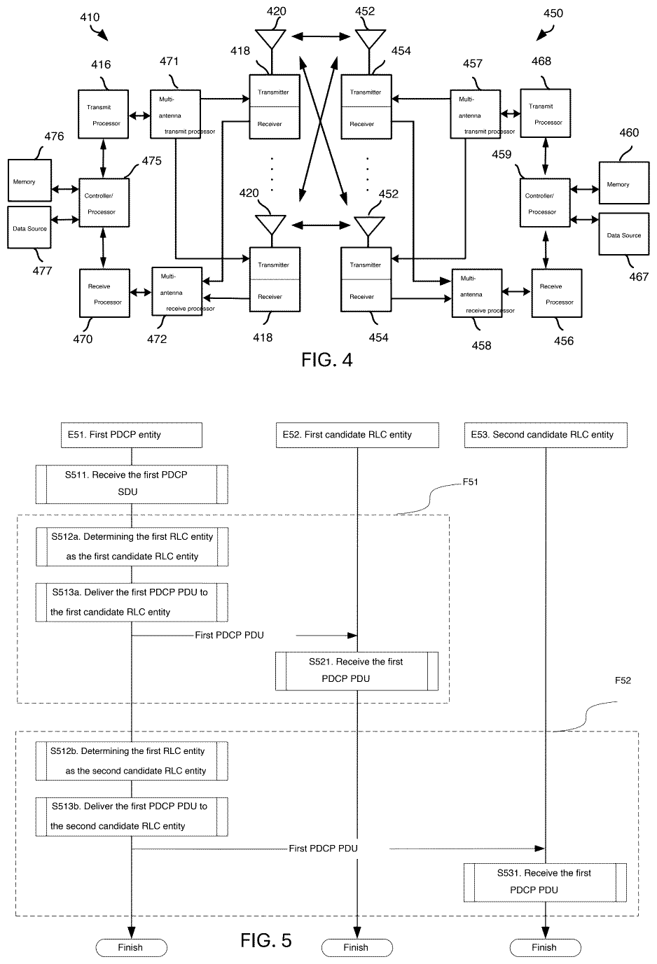

Embodiment 4 illustrates a hardware module schematic diagram of a communication device according to an embodiment of the present application, as shown in FIG. 4. FIG. 4 is a block diagram of a first communication device 450 and a second communication device 410 communicating with each other in an access network.

The first communication device 450 includes a controller/processor 459, a memory 460, a data source 467, a transmit processor 468, a receive processor 456, a multi-antenna transmit processor 457, a multi-antenna receive processor 458, a transmitter/receiver 454 and an antenna 452.

The second communication device 410 includes a controller/processor 475, a memory 476, a data source 477, a receive processor 470, a transmit processor 416, a multi-antenna receive processor 472, a multi-antenna transmit processor 471, a transmitter/receiver 418 and an antenna 420.

In the transmission from the second communication device 410 to the first communication device 450, at the second communication device 410, the upper layer data packets from the core network or the upper layer data packets from the data source 477 are provided to the controller/processor 475. The core network and the data source 477 represent all the protocol layers above the L2 layer. The controller/processor 475 implements the functionality of the L2 layer. In the transmission from the second communication device 410 to the first communication device 450, the controller/processor 475 provides header compression, encryption, packet segmentation and reordering, multiplexing between logical and transport channels, and radio resource allocation to the first communication device 450 based on various priority metrics. The controller/processor 475 is also responsible for the retransmission of lost packets and signaling to the first communication device 450. The transmit processor 416 and the multi-antenna transmit processor 471 implement various signal processing functions for the L1 layer (i.e., the physical layer). The transmit processor 416 implements coding and interleaving to facilitate forward error correction (FEC) at the second communication device 410, as well as mapping of signal constellations based on various modulation schemes (e.g., binary phase shift keying (BPSK), quadrature phase shift keying (QPSK), M-phase shift keying (M-PSK), M-quadrature amplitude modulation (M-QAM)). The multi-antenna transmit processor 471 performs digital spatial precoding, including codebook-based precoding and non-codebook-based precoding, and beamforming processing on the coded and modulated symbols to generate one or more spatial streams. The transmit processor 416 then maps each spatial stream to a subcarrier, multiplexes it with a reference signal (e.g., a pilot) in the time domain and/or frequency domain, and then uses an inverse fast Fourier transform (IFFT) to generate a physical channel carrying a time-domain multi-carrier symbol stream. The multi-antenna transmit processor 471 then performs a transmit analog precoding/beamforming operation on the time-domain multi-carrier symbol stream. Each transmitter 418 converts the baseband multi-carrier symbol stream provided by the multi-antenna transmit processor 471 into a radio frequency stream, and then provides it to a different antenna 420.

In the transmission from the second communication device 410 to the first communication device 450, at the first communication device 450, each receiver 454 receives a signal through its corresponding antenna 452. Each receiver 454 recovers the information modulated onto the RF carrier and converts the RF stream into a baseband multi-carrier symbol stream and provides it to the receiving processor 456. The receiving processor 456 and the multi-antenna receiving processor 458 implement various signal processing functions of the L1 layer. The multi-antenna receiving processor 458 performs a receiving analog precoding/beamforming operation on the baseband multi-carrier symbol stream from the receiver 454. The receiving processor 456 uses a fast Fourier transform (FFT) to convert the baseband multi-carrier symbol stream after the receiving analog precoding/beamforming operation from the time domain to the frequency domain. In the frequency domain, the physical layer data signal and the reference signal are demultiplexed by the receiving processor 456, wherein the reference signal will be used for channel estimation, and the data signal is recovered after multi-antenna detection in the multi-antenna receiving processor 458 to any spatial stream destined for the first communication device 450. The symbols on each spatial stream are demodulated and recovered in the receiving processor 456, and soft decisions are generated. The receiving processor 456 then decodes and deinterleaves the soft decisions to recover the upper layer data and control signals transmitted by the second communication device 410 on the physical channel. The upper layer data and control signals are then provided to the controller/processor 459. The controller/processor 459 implements the functions of the L2 layer. The controller/processor 459 may be associated with a memory 460 that stores program codes and data. The memory 460 may be referred to as a computer-readable medium. In the transmission from the second communication device 410 to the first communication device 450, the controller/processor 459 provides multiplexing between transport and logical channels, packet reassembly, decryption, header decompression, control signal processing to recover higher layer data packets from the second communication device 410. The upper layer data packets are then provided to all protocol layers above the L2 layer. Various control signals may also be provided to the L3 for L3 processing.

In the transmission from the first communication device 450 to the second communication device 410, at the first communication device 450, the upper layer data packets are provided to the controller/processor 459 using the data source 467. The data source 467 represents all the protocol layers above the L2 layer. Similar to the transmission function at the second communication device 410 described in the transmission from the second communication device 410 to the first communication device 450, the controller/processor 459 implements header compression, encryption, packet segmentation and reordering, and multiplexing between logical and transport channels, and implements L2 layer functions for user plane and control plane. The controller/processor 459 is also responsible for the retransmission of lost packets and signaling to the second communication device 410. The transmit processor 468 performs modulation mapping and channel coding processing, and the multi-antenna transmit processor 457 performs digital multi-antenna spatial precoding, including codebook-based precoding and non-codebook-based precoding, and beamforming processing. Then, the transmit processor 468 modulates the generated spatial stream into a multi-carrier/single-carrier symbol stream, which is then provided to different antennas 452 via the transmitter 454 after analog precoding/beamforming operations in the multi-antenna transmit processor 457. Each transmitter 454 first converts the baseband symbol stream provided by the multi-antenna transmit processor 457 into a radio frequency symbol stream, and then provides it to the antenna 452.

In the transmission from the first communication device 450 to the second communication device 410, the functions at the second communication device 410 are similar to the reception functions at the first communication device 450 described in the transmission from the second communication device 410 to the first communication device 450. Each receiver 418 receives a radio frequency signal through its corresponding antenna 420, converts the received radio frequency signal into a baseband signal, and provides the baseband signal to the multi-antenna reception processor 472 and the reception processor 470. The reception processor 470 and the multi-antenna reception processor 472 jointly implement the functions of the L1 layer. The controller/processor 475 implements the L2 layer functions. The controller/processor 475 can be associated with a memory 476 that stores program codes and data. The memory 476 can be referred to as a computer-readable medium. In the transmission from the first communication device 450 to the second communication device 410, the controller/processor 475 provides multiplexing between transport and logical channels, packet reassembly, decryption, header decompression, control signal processing to recover the upper layer data packets from the first communication device 450. The upper layer data packets from the controller/processor 475 may be provided to the core network or all protocol layers above the L2 layer, and various control signals may also be provided to the core network or L3 for L3 processing.

As an embodiment, the first communication device 450 apparatus includes: at least one processor and at least one memory, the at least one memory including computer program code; the at least one memory and the computer program code are configured to be used together with the at least one processor, and the first communication device 450 apparatus at least: receives a first PDCP SDU; starts a first timer as a response to receiving the first PDCP SDU; when the first timer is in a running state, delivers the first PDCP PDU to the first RLC entity for sending; wherein the first PDCP PDU is a data unit after the first PDCP SDU is processed by the first PDCP entity; the first RLC entity is one of a first candidate RLC entity and a second candidate RLC entity, and whether the first RLC entity is the first candidate RLC entity or the second candidate RLC entity is related to the value of the first timer; the first candidate RLC entity and the second candidate RLC entity are respectively associated with the first PDCP entity; the data unit included in the first candidate RLC entity is sent via a direct path; the data unit included in the second candidate RLC entity is sent via a non-direct path.

As an embodiment, the first communication device 450 apparatus includes: a memory storing a computer-readable instruction program, wherein the computer-readable instruction program generates an action when executed by at least one processor, and the action includes: receiving a first PDCP SDU; starting a first timer as a response to receiving the first PDCP SDU; when the first timer is in a running state, delivering the first PDCP PDU to the first RLC entity for sending; wherein the first PDCP PDU is a data unit after the first PDCP SDU is processed by the first PDCP entity; the first RLC entity is one of a first candidate RLC entity and a second candidate RLC entity, and whether the first RLC entity is the first candidate RLC entity or the second candidate RLC entity is related to the value of the first timer; the first candidate RLC entity and the second candidate RLC entity are respectively associated with the first PDCP entity; the data unit included in the first candidate RLC entity is sent via a direct path; the data unit included in the second candidate RLC entity is sent via a non-direct path.

As an embodiment, the second communication device 410 apparatus includes: at least one processor and at least one memory, the at least one memory includes computer program code; the at least one memory and the computer program code are configured to be used together with the at least one processor, and the second communication device 410 apparatus at least: sends a first message.

As an embodiment, the second communication device 410 comprises: a memory storing a computer-readable instruction program, wherein the computer-readable instruction program generates an action when executed by at least one processor, and the action comprises: sending a first message.

As an embodiment, the first communication device 450 corresponds to the first node in this application.

As an embodiment, the first communication device 450 is a UE.

As an embodiment, the first communication device 450 is a layer 3 relay node.

As an embodiment, the second communication device 410 corresponds to the second node in this application.

As an embodiment, the second communication device 410 is a base station.

As an embodiment, the second communication device 410 corresponds to the third node in this application.

As an embodiment, the second communication device 410 is a layer 2 relay node.

As an embodiment, at least one of the antenna 452, the transmitter 454, the multi-antenna receiving processor 458, the receiving processor 456 or the controller/processor 459 is used to receive the first PDCP in the present application. SDU.

As an embodiment, at least one of the antenna 452, the transmitter 454, the multi-antenna transmit processor 457, the transmit processor 468 or the controller/processor 459 is used to submit the first PDCP in the present application. PDU.

As an embodiment, at least one of the antenna 452, the transmitter 454, the multi-antenna transmit processor 457, the transmit processor 468 or the controller/processor 459 is used to send the first indication in the present application.

As an embodiment, at least one of the antenna 420, the receiver 418, the multi-antenna transmit processor 471, the transmit processor 416 or the controller/processor 475 is used to send the first message in the present application.

As an embodiment, at least one of the antenna 452, the transmitter 454, the multi-antenna receiving processor 458, the receiving processor 456 or the controller/processor 459 is used to receive the first message in the present application.

### Example 5

Embodiment 5 illustrates a signal transmission flow chart according to an embodiment of the present application, as shown in FIG. 5. In FIG. 5, the first PDCP entity E51, the first candidate RLC entity E52 and the second candidate RLC entity E53 are all located at the first node, the first PDCP entity E51 and the first candidate RLC entity E52 communicate through an inter-layer interface, and the first PDCP entity E51 and the second candidate RLC entity E53 communicate through an inter-layer interface.

For the first PDCP entity E51, in step S511, a first PDCP SDU; in step S512a, determining the first RLC entity as the first candidate RLC entity; in step S513a, the first PDCP The PDU is delivered to the first candidate RLC entity; in step S512b, the first RLC entity is determined to be the second candidate RLC entity; in step S513b, the first PDCP The PDU is delivered to the second candidate RLC entity.

For the first candidate RLC entity E52, in step S521, a first PDCP PDU.

For the second candidate RLC entity E53, in step S531, the first PDCP PDU.

It should be noted that the steps in the dotted box F51 and the dotted box F52 are performed either one or the other, that is, they are not performed at the same time.

In Example 5, a first PDCP SDU is received; as a response to receiving the first PDCP SDU, a first timer is started; when the first timer is in a running state, the first PDCP PDU is delivered to the first RLC entity for transmission; wherein the first PDCP PDU is a data unit after the first PDCP SDU is processed by the first PDCP entity; the first RLC entity is one of the first candidate RLC entity and the second candidate RLC entity, and whether the first RLC entity is the first candidate RLC entity or the second candidate RLC entity is related to the value of the first timer; the first candidate RLC entity and the second candidate RLC entity are associated with the first PDCP entity respectively; the data unit included in the first candidate RLC entity is sent through a direct path; the data unit included in the second candidate RLC entity is sent through a non-direct path; when the value of the first timer is greater than a first threshold, the first RLC entity is the first candidate RLC entity; when the value of the first timer is less than a first threshold, whether the first RLC entity is the first candidate RLC entity or the second candidate RLC entity is related to the reference data amount; wherein the reference data amount is the PDCP data amount in the first PDCP entity and the first candidate RLC The total amount of RLC data waiting for initial transmission in the entity and the second candidate RLC entity.

As an embodiment, when the value of the first timer is greater than a first threshold, the first RLC entity is the first candidate RLC entity.

As an embodiment, when the value of the first timer is equal to the first threshold, the first RLC entity is the first candidate RLC entity.

As an embodiment, when the value of the first timer is less than the first threshold, the first RLC entity is the second candidate RLC entity.

As an embodiment, when the value of the first timer is equal to the first threshold, the first RLC entity is the second candidate RLC entity.

As an embodiment, when the value of the first timer is less than the first threshold, the first RLC entity is one of the first candidate RLC entity or the second candidate RLC entity.

As an embodiment, when the value of the first timer is equal to the first threshold, the first RLC entity is one of the first candidate RLC entity or the second candidate RLC entity.

As a sub-embodiment of the above two embodiments, the first node selects the first RLC entity as the first candidate RLC entity or the second candidate RLC entity by itself.

As a sub-embodiment of the above two embodiments, the first node selects the first RLC entity as the first candidate RLC entity or the second candidate RLC entity with equal probability.

As an embodiment, when the value of the first timer is less than the first threshold, whether the first RLC entity is the first candidate RLC entity or the second candidate RLC entity is related to the amount of reference data.

As an embodiment, when the value of the first timer is equal to the first threshold, whether the first RLC entity is the first candidate RLC entity or the second candidate RLC entity is related to the reference data amount.

As an embodiment, when the value of the first timer is less than the first threshold, the reference data amount is used to determine whether the first RLC entity is the first candidate RLC entity or the second candidate RLC entity.

As an embodiment, when the value of the first timer is equal to the first threshold, the reference data amount is used to determine whether the first RLC entity is the first candidate RLC entity or the second candidate RLC entity.

As a sub-embodiment of the above four embodiments, the first node is configured as a secondary RLC entity.

As an embodiment, when the value of the first timer is less than the first threshold and the reference data amount is less than a second threshold, the first RLC entity is a primary RLC entity, and the primary RLC entity is one of the first candidate RLC entity or the second candidate RLC entity.

As an embodiment, when the value of the first timer is equal to the first threshold and the reference data amount is less than the second threshold, the first RLC entity is a primary RLC entity, and the primary RLC entity is one of the first candidate RLC entity or the second candidate RLC entity.

As an embodiment, the network configures one of the first candidate RLC entity or the second candidate RLC entity as the primary RLC entity, and the other of the first candidate RLC entity or the second candidate RLC entity as a secondary RLC entity.

As a sub-embodiment of the above embodiment, the first candidate RLC entity is the primary RLC entity, and the second candidate RLC entity is the secondary RLC entity.

As a sub-embodiment of the above embodiment, the first candidate RLC entity is the secondary RLC entity, and the second candidate RLC entity is the primary RLC entity.

As an embodiment, the primary RLC entity belongs to the primary path.

As an embodiment, the auxiliary RLC entity belongs to a non-primary path.

As an embodiment, the secondary RLC entity belongs to a secondary path. [symbol] path).

As an embodiment, the secondary RLC entity is a split secondary RLC entity (split secondary RLC entity).

As an embodiment, when the value of the first timer is less than the first threshold and the reference data amount is not less than the second threshold, the first RLC entity is one of the first candidate RLC entity or the second candidate RLC entity.

As an embodiment, when the value of the first timer is equal to the first threshold and the reference data amount is not less than the second threshold, the first RLC entity is one of the first candidate RLC entity or the second candidate RLC entity.

As a sub-embodiment of the above two embodiments, the first node selects the first RLC entity as the first candidate RLC entity or the second candidate RLC entity by itself.

As a sub-embodiment of the above two embodiments, the first node selects the first RLC entity as the first candidate RLC entity or the second candidate RLC entity with equal probability.

As an embodiment, the second threshold is configured by the network.

As an embodiment, the second threshold is preconfigured.

As an embodiment, the second threshold is configured for split bearer.

As an embodiment, the second threshold is configured for a PDCP entity associated with multiple RLC entities.

As an embodiment, the second threshold is configured for the first PDCP entity.

As an embodiment, the second threshold is indicated by ul-DataSplitThreshold (uplink data split threshold).

As an embodiment, the reference data amount is the total amount of the PDCP data in the first PDCP entity and the RLC data amounts waiting for initial transmission in the first candidate RLC entity and the second candidate RLC entity.

As an embodiment, the amount of PDCP data in the first PDCP entity includes PDCP data PDUs that have not yet been constructed. The amount of data in the SDU.

As an embodiment, the amount of PDCP data in the first PDCP entity includes the amount of PDCP data PDU data that has not yet been delivered to a lower layer.

As an embodiment, the amount of PDCP data in the first PDCP entity includes PDCP data to be retransmitted The amount of data in the SDU; wherein the first PDCP entity is used for AM (Acknowledged Mode) DRB.

As an embodiment, the amount of PDCP data in the first PDCP entity includes the amount of data of the PDCP data PDU to be retransmitted; wherein the first PDCP entity is used for AM DRB.

As an embodiment, the amount of PDCP data in the first PDCP entity includes the amount of data of the PDCP control PDU.

As an embodiment, the amount of RLC data waiting for initial transmission in the first candidate RLC entity and the second candidate RLC entity respectively includes the amount of data of RLC SDU and RLC SDU segment that have not been included in the RLC data PDU.

As an embodiment, the amount of RLC data waiting for initial transmission in the first candidate RLC entity and the second candidate RLC entity respectively includes RLC data PDUs waiting for initial transmission.

As an embodiment, the amount of RLC data waiting for initial transmission in the first candidate RLC entity and the second candidate RLC entity respectively includes an estimated STATUS The amount of data in the PDU; wherein the STATUS The PDU has been activated and the t-StatusProhitib (status prohibit timer) is not running or has not expired.

### Example 6

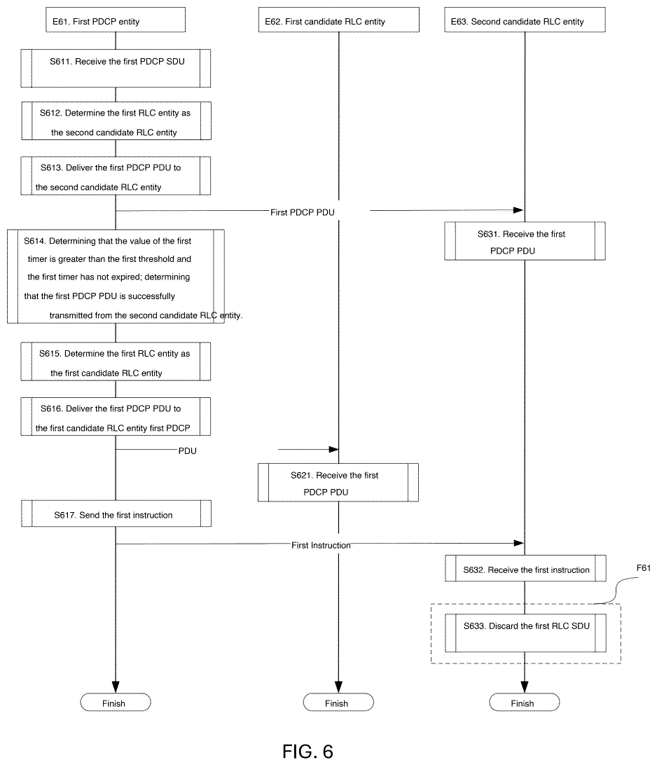

Embodiment 6 illustrates another signal transmission flow chart according to an embodiment of the present application, as shown in FIG. 6. In FIG. 6, the first PDCP entity E61, the first candidate RLC entity E62 and the second candidate RLC entity E63 are all located in the first node, the first PDCP entity E61 and the first candidate RLC entity E62 communicate through the inter-layer interface, and the first PDCP entity E61 and the second candidate RLC entity E63 communicate through the inter-layer interface.

For the first PDCP entity E61, in step S611, a first PDCP SDU; in step S612, determining the first RLC entity as the second candidate RLC entity; in step S613, the first PDCP The PDU is delivered to the second candidate RLC entity; in step S614, it is determined that the value of the first timer is greater than the first threshold and the first timer has not expired, and it is determined that the first PDCP is not received from the second candidate RLC entity In step S615, the first RLC entity is determined to be the first candidate RLC entity; in step S616, the first PDCP The PDU is delivered to the first candidate RLC entity; in step S617, a first indication is sent.

For the first candidate RLC entity E62, in step S621, a first PDCP PDU.

For the second candidate RLC entity E63, in step S631, the first PDCP PDU; receiving a first indication in step S632; discarding a first RLC in step S633 SDU.

In Example 6, a first PDCP SDU is received; as a response to receiving the first PDCP SDU, a first timer is started; when the first timer is in a running state, the first PDCP PDU is delivered to the first RLC entity for sending; wherein the first PDCP PDU is a data unit after the first PDCP SDU is processed by the first PDCP entity; the first RLC entity is one of the first candidate RLC entity and the second candidate RLC entity, and whether the first RLC entity is the first candidate RLC entity or the second candidate RLC entity is related to the value of the first timer; the first candidate RLC entity and the second candidate RLC entity are respectively associated with the first PDCP entity; the data unit included in the first candidate RLC entity is sent via a direct path; the data unit included in the second candidate RLC entity is sent via a non-direct path; the first PDCP PDU is delivered to the first candidate RLC entity for sending; wherein the value of the first timer is greater than the first threshold and the first timer has not expired; the first PDCP entity has not received an indication from the second candidate RLC entity that the first PDCP PDU has been successfully sent; the first RLC entity is the second candidate RLC entity; a first indication is sent, and the first indication is used to instruct the first RLC entity to discard the first PDCP PDU; when the first RLC SDU or the segment of the first RLC SDU has not been delivered to a lower layer, discarding the first RLC SDU; wherein the first RLC SDU is the first PDCP PDU.

It should be noted that the steps in the dashed box F61 are only executed when the first RLC SDU or a segment of the first RLC SDU is not transferred to a lower layer.

As an embodiment, the phrase whether the first RLC entity is the first candidate RLC entity or the second candidate RLC entity is related to the value of the first timer and includes: the first RLC entity is the second candidate RLC entity; when the value of the first timer is greater than the first threshold and the first timer has not expired and the first PDCP entity has not received an indication of successful sending of the first PDCP PDU from the second candidate RLC entity, the first PDCP PDU is delivered to the first candidate RLC entity for sending.

As an embodiment, the phrase whether the first RLC entity is the first candidate RLC entity or the second candidate RLC entity is related to the value of the first timer and includes: the first RLC entity is the second candidate RLC entity; when the value of the first timer is not less than the first threshold and the first timer has not expired and the first PDCP entity has not received an indication of successful sending of the first PDCP PDU from the second candidate RLC entity, the first PDCP PDU is delivered to the first candidate RLC entity for sending.

As an embodiment, a first PDCP SDU is received, and as a response to receiving the first PDCP SDU, a first timer is started; when the first timer is in a running state, the first PDCP PDU is delivered to the second candidate RLC entity for sending; when the value of the first timer is greater than the first threshold and the first timer has not expired, and the first PDCP entity has not received an indication of successful sending of the first PDCP PDU from the second candidate RLC entity, the first PDCP PDU is delivered to the first candidate RLC entity for sending.

As an embodiment, the second candidate RLC entity is AM (Acknowledged Mode) RLC entity, the first PDCP entity receives a successfully sent PDCP from the second candidate RLC entity An indication of a PDU, the indication including the PDCP Serial number of the PDU.

As an embodiment, a PDCP data PDU includes a PDCP sequence number.

As an embodiment, the PDCP sequence number is a non-negative integer.

As an embodiment, the second candidate RLC entity sends a poll to a peer RLC entity of the second candidate RLC entity, wherein the poll is used to trigger the peer RLC entity of the second candidate RLC entity to feedback a status (STATUS) PDU; the status PDU indicates an RLC SDU or one RLC Whether a part of the SDU was sent successfully.

As an embodiment, a status PDU is received from the peer RLC entity of the second candidate RLC entity, and when the status PDU indicates a status PDU for an RLC When the SDU is a positive acknowledgement, the second candidate RLC entity indicates to the first PDCP entity the one RLC Successful transmission of SDU.

As an embodiment, the counterpart RLC entity of the second candidate RLC entity is located at a node other than the first node.

As an embodiment, the first node and a node other than the first node are not co-located.

As an embodiment, the counterpart RLC entity of the second candidate RLC entity is located at the third node in the present application.

As an embodiment, the first node and the third node are connected via an air interface.

As an embodiment, the air interface is Uu.

As an embodiment, the air interface is PC5.

As an embodiment, the first node and a node other than the first node are connected via a wired link.

As an embodiment, the second candidate RLC entity is an AM (Acknowledged Mode) RLC entity.

As an embodiment, the second candidate RLC entity consists of a transmitting side (transmitting side) and a receiving side (receiving side).

As an embodiment, the phrase delivering the first PDCP PDU to the first candidate RLC entity for transmission includes: copying the first PDCP PDU and delivers the first PDCP PDU to the first candidate RLC entity for sending.

As an embodiment, the first candidate RLC entity is an AM RLC entity.

As an embodiment, the first candidate RLC entity is a UM (Unacknowledged Mode) RLC entity.

As an embodiment, the first candidate RLC entity is a TM (Transparent Mode, transparent mode) RLC entity.

As an embodiment, the first candidate RLC entity consists of a transmitting side and a receiving side.

As an embodiment, the first candidate RLC entity is configured as a sending RLC entity.

As an embodiment, a first indication is sent, where the first indication is used to instruct the first RLC entity to discard the first PDCP PDU; wherein the first RLC entity is the second candidate RLC entity.

As an embodiment, the first indication is an inter-layer indication.

As an embodiment, the first PDCP entity sends the first indication to the first RLC entity; wherein the first RLC entity is the second candidate RLC entity.

As an embodiment, the first indication includes the first PDCP Serial number of the PDU.

As an embodiment, when the first RLC SDU or a segment of the first RLC SDU is not delivered to a lower layer, the second candidate RLC entity discards the first RLC SDU; wherein the first RLC SDU is the first PDCP PDU.

As an embodiment, the phrase that the first RLC SDU is the first PDCP PDU includes: the first RLC SDU is a duplication of the first PDCP PDU.

As an embodiment, the lower layer is a layer below the RLC sublayer.

As an embodiment, the lower layer is a MAC (Medium Access Control) sublayer.

As an embodiment, the segment of the first RLC SDU includes at least 1 bit of the first RLC SDU.

As an embodiment, when receiving the first indication, if the first RLC SDU or the segment of the first RLC SDU has not been delivered to a lower layer, the second candidate RLC entity discards the RLC indicated by the first indication. SDU.

As an embodiment, when the logical channel corresponding to the second candidate RLC entity is scheduled, the data transmitted by the second candidate RLC entity is passed to the lower layer.

As an embodiment, when the first RLC After the second candidate RLC entity completes processing of the SDU, the first RLC SDU is delivered to the lower layer.

### Example 7

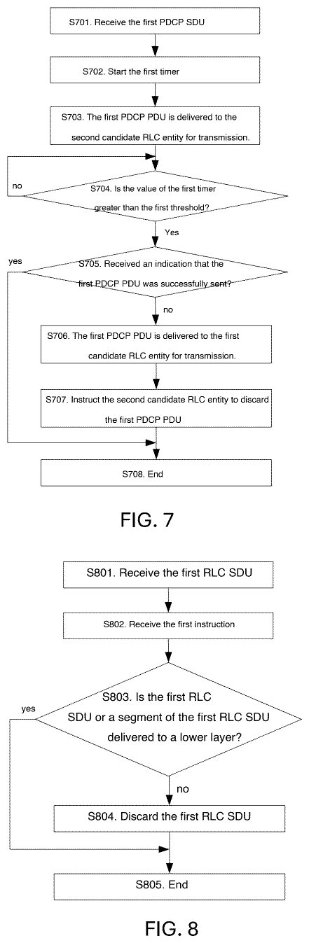

Embodiment 7 illustrates a signal processing flow chart according to an embodiment of the present application, as shown in FIG. 7. The steps in FIG. 7 are executed at the first node.

In FIG. 7, in step S701, a first PDCP is received. SDU; in step S702, start a first timer; in step S703, the first PDCP The PDU is delivered to the second candidate RLC entity for transmission; in step S704, it is determined whether the value of the first timer is greater than the first threshold value, if yes, step S705 is executed, if no, step S704 is jumped back to; in step S705, it is determined whether the first PDCP is received If yes, jump to step S708, if no, execute step S706; in step S706, the first PDCP The PDU is delivered to the first candidate RLC entity for transmission; in step S707, the second candidate RLC entity is instructed to discard the first PDCP PDU.

As an embodiment, the steps in FIG. 7 are performed in the first PDCP entity.

### Example 8

Embodiment 8 illustrates another signal processing flow chart according to an embodiment of the present application, as shown in FIG. 8. The steps in FIG. 8 are executed at the first node.

In FIG. 8, in step S801, a first RLC is received. SDU; receiving a first indication in step S802; determining in step S803 the first RLC SDU or the first RLC Whether the SDU segment is passed to a lower layer, if yes, jump to step S805, if no, execute step S804; in step S804, discard the first RLC SDU.

As an embodiment, the steps in FIG. 8 are performed in the second candidate RLC entity.

As an embodiment, the first RLC SDU is the first PDCP PDU.

As an embodiment, when the first RLC SDU or the first RLC When the SDU segments are passed to the lower layers, the first RLC is discarded SDU.

### Example 9

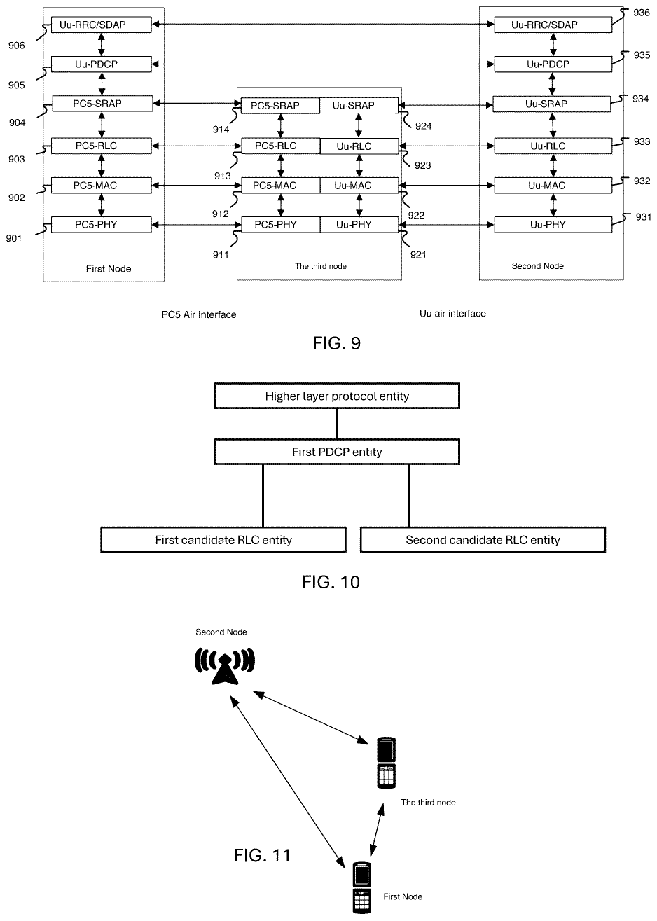

Embodiment 9 illustrates a schematic diagram of a wireless protocol architecture for relay transmission according to an embodiment of the present application, as shown in FIG. 9.

In FIG. 9, in relay transmission, taking data sent from the first node to the second node via the third node as an example (data sent from the second node to the first node via the third node can be obtained in the same way): the first target data is processed in sequence by the Uu-PDCP sublayer 905, PC5-SRAP (Sidelink Relay Adaptation Protocol) sublayer 904 and PC5-RLC sublayer 903 on the first node side, and the first target MAC is generated in the PC5-MAC sublayer 902. PDU, then passed to the PC5-PHY layer 901, and then transmitted to the PC5-PHY layer 911 of the third node through the PC5 air interface, and then processed by the PC5-MAC sublayer 912 and the PC5-RLC sublayer 913 in sequence to restore the first RLC data; the first RLC data is processed by the PC5-SRAP sublayer 914 and the Uu-SRAP sublayer 924 and regenerated into the second RLC data in the Uu-RLC sublayer 923, and then processed by the Uu-MAC sublayer 922 to generate the second target MAC PDU and pass it to the Uu PHY layer 921; then transmitted to the Uu-PHY layer 931 of the second node through the Uu air interface, and then restored to the second target MAC PDU through the Uu-MAC sublayer 932, and then restored to the first target data through the Uu-RLC sublayer 933, the Uu-SRAP sublayer 934 and the Uu-PDCP sublayer 935 in sequence.

The third node in FIG. 9 is layer 2 U 2 N relay node.

In FIG. 9, the data forwarded at the third node is processed by the MAC sublayer, the RLC sublayer and the SRAP sublayer but not by the PDCP sublayer; the PC5 air interface is the air interface between the first node and the third node, and the protocol entities PC5-SRAP 904 and PC5-SRAP 914, PC5-RLC 903 and PC5-RLC 913, PC5-MAC 902 and PC5-MAC 912, PC5-PHY 901 and PC5-PHY 911 related to the PC5 interface are terminated at the first node and the third node respectively; the Uu air interface is the air interface between the third node and the second node, and the protocol entities Uu-SRAP 924 and Uu-SRAP 934, Uu-RLC 923 and Uu-RLC 933, Uu-MAC 922 and Uu-MAC 932, Uu-PHY 921 and Uu-PHY 931 are terminated at the third node and the second node respectively; higher layer protocol entities Uu-RRC/SDAP 906 and Uu-RRC/SDAP 936, Uu-PDCP 905 and Uu-PDCP 935 are terminated at the first node and the second node respectively.

As an embodiment, the PC5-SRAP 904 is a peer SRAP entity of the PC5-SRAP 914.

As an embodiment, the Uu-SRAP 924 is the peer SRAP entity of the Uu-SRAP 934.

As an embodiment, the PC5-RLC 903 is the opposite RLC entity of the PC5-RLC 913.

As an embodiment, the Uu-RLC 923 is the opposite RLC entity of the Uu-RLC 933.

As an embodiment, the Uu-PDCP 905 is the peer PDCP entity of the Uu-PDCP 935.

As an embodiment, the first PDCP entity is the Uu-PDCP 905, the second candidate RLC entity is the PC5-RLC 903, and the opposite RLC entity of the second candidate RLC entity is the PC5-RLC 913.

As an embodiment, the second candidate RLC entity is located at the first node, and the opposite RLC entity of the second candidate RLC entity is located at the third node.

As an embodiment, the first candidate RLC entity is located at a first node, and the opposite RLC entity of the first candidate RLC entity is located at a second node.

[symbol] -to-point communication of each hop; the PDCP sublayer and RRC/SDAP sublayer are responsible for peer-to-peer communication.

As an embodiment, the SRAP sublayer implements UE Determined by ID (User Equipment Identity) and Bearer Identity.

As an embodiment, the SRAP sublayer implements the RLC channel (egress RLC channel).

As an embodiment, the SRAP sublayer implements bearer mapping. [symbol] mapping) function.

As an embodiment, the SRAP sublayer implements a routing function.

In FIG. 9, the routing function sends a data packet from the first node to the second node.

In FIG. 9, the second node is a NG-RAN node and the first node is a UE.

[symbol] 201 in Embodiment 2.

[symbol] 241 in Embodiment 2.

As an embodiment, the second node in FIG. 9 corresponds to the gNB 203 in Embodiment 2.

### Example 10

Embodiment 10 illustrates a schematic diagram of a first PDCP entity, a first candidate RLC entity and a second candidate RLC entity according to an embodiment of the present application, as shown in FIG. 10. In FIG. 10, the first PDCP entity, the first candidate RLC entity and the second candidate RLC entity are all located at the first node.

As an embodiment, the first PDCP entity is associated with the first wireless bearer.

As an embodiment, the bearer served by the first candidate RLC entity and the second candidate RLC entity is the first radio bearer, and the first PDCP entity is used to send data of the first radio bearer.

As an embodiment, the first radio bearer is a DRB, an SRB or an MRB.

As an embodiment, the protocol structure shown in FIG. 10 is used for the first radio bearer.

As an embodiment, the first radio bearer is configured as a split bearer. [symbol] bearer).

As an embodiment, the higher layer protocol entity in FIG. 10 is RRC, and FIG. 8 is for SRB.

As an embodiment, the higher layer protocol entity in FIG. 10 is SDAP, and FIG. 8 is for DRB or MRB.

As an embodiment, the first PDCP entity is configured with PDCP recovery.

As an embodiment, the first PDCP entity is configured with PDCP recovery including: when the second candidate RLC entity fails to successfully send an RLC within the duration indicated by the first threshold value SDU, the PDCP The PDU is delivered by the first PDCP entity to the first candidate RLC entity for transmission.

As an embodiment, the PDCP received from a higher layer protocol entity The PDCP PDU formed by processing the SDU by the first PDCP entity is sent through one of the first candidate RLC entity or the second candidate RLC entity.

As an embodiment, the first candidate RLC entity is for uplink communication, and the second candidate RLC entity is for sidelink communication.

As a sub-embodiment of the above embodiment, the first radio bearer is an uplink radio bearer.

As an embodiment, the first candidate RLC entity is for secondary link direct path communication, and the second candidate RLC entity is for secondary link indirect path communication.

As a sub-embodiment of the above embodiment, the first radio bearer is a sidelink radio bearer (Sidelink Radio Bearer, SLRB).

### Example 11

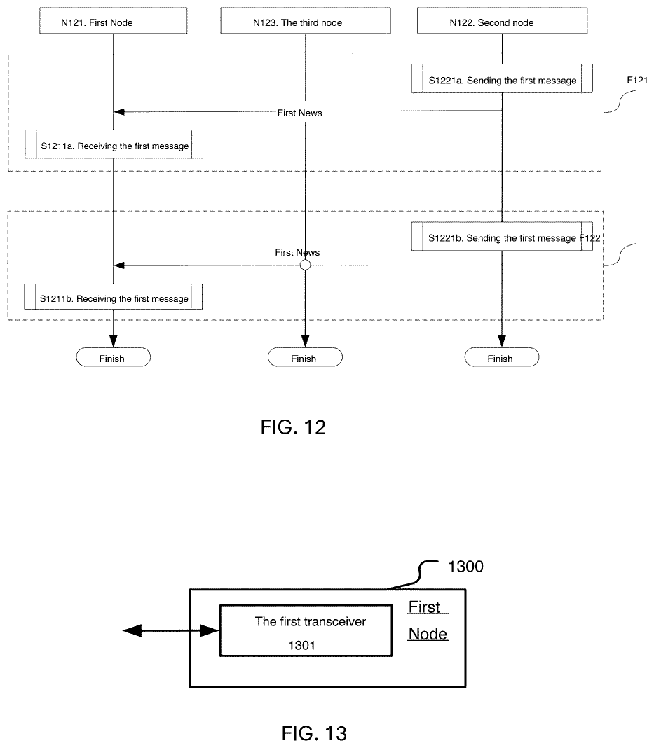

Embodiment 11 illustrates a schematic diagram of a topological structure according to an embodiment of the present application, as shown in FIG. 11.

As an embodiment, the first node is configured with multiple paths, and the multiple paths include a direct path (direct path) and an indirect path (indirect path).

As an embodiment, the direct connection path refers to data being transmitted from a source node to a destination receiver through only one air interface.

As an embodiment, the non-direct path refers to data being transmitted from a source node to a destination receiver through at least two air interfaces.

As an embodiment, the at least two air interfaces include a Uu air interface and a PC5 air interface.

As an embodiment, the at least two air interfaces include at least two PC5 air interfaces.

As an embodiment, the at least two air interfaces include a backhaul air interface and an access air interface.

As an embodiment, when forwarded through the third node, the communication between the first node and the second node is a non-direct path.

As an embodiment, when forwarding is not performed through the third node, the communication between the first node and the second node is a direct connection path.

As a sub-embodiment of the above two embodiments, the non-direct connection path is a main path.

As a sub-embodiment of the above two embodiments, the direct connection path is a main path.

As an embodiment, the first node is a UE.

As an embodiment, the third node shown is a layer 2 relay node.

As an embodiment, the third node shown is a layer 2 U 2 N relay UE.

As an embodiment, the third node and the first node belong to the same cell group.

As an embodiment, the third node and the first node belong to different cell groups.

As an embodiment, the second node is a NG-RAN node.

As an embodiment, the first node in FIG. 11 corresponds to the UE 201 in Embodiment 2.

As an embodiment, the third node in FIG. 11 corresponds to the UE 241 in Embodiment 2.

As an embodiment, the second node in FIG. 11 corresponds to the gNB 203 in Embodiment 2.

### Example 12

Embodiment 12 illustrates a wireless signal transmission flow chart according to an embodiment of the present application, as shown in FIG. 12. In FIG. 12, the first node and the second node communicate via the Uu air interface, the first node and the third node communicate via the PC5 air interface, and the third node and the second node communicate via the Uu air interface.

For the first node N121, the first message is received in step S1211a; and the first message is received in step S1211b.

For the second node N122, a first message is sent in step S1221a; and a first message is sent in step S1221b.

It should be noted that the steps in the dotted line frame F121 and the steps in the dotted line frame F122 can be performed alternatively.

It should be noted that the first message in the dotted box F121 is transmitted through a direct path, and the first message in the dotted box F122 is transmitted through an indirect path, that is, through relay forwarding.

It should be noted that, although not shown in detail, the steps in the dashed box F122 include the third node receiving the first message from the second node, and the third node forwarding the first message to the first node.

As an embodiment, the second node is a base station of a service cell of the first node.

As an embodiment, the second node is the TRP of the service cell of the first node.

As an embodiment, the serving cell belongs to a master cell group. [symbol] cell group).

As an embodiment, the serving cell belongs to a secondary cell group.

As an embodiment, the serving cell is a primary cell. [symbol] Cell).

As an embodiment, the service cell is a secondary cell (Secondary Cell).

As an embodiment, the first transceiver receives a first message, wherein the first message indicates a first expiration value and the first threshold; wherein the first expiration value is used to determine expiration of the first timer.

As an embodiment, the first message is a high-level message.

As an embodiment, the first message is RRC (Radio Resource Control, radio resource control) signaling.

As an embodiment, the first message includes all or part of an IE (Information Element) in an RRC signaling.

As an embodiment, the first message includes all or part of a field in an IE in an RRC signaling.

As an embodiment, the first message includes configuration information of the first PDCP entity.

As an embodiment, the first message indicates a first expiration value and the first threshold.

As an embodiment, the first message includes a first sub-message and a second sub-message, and the first sub-message and the second sub-message respectively indicate the first expiration value and the first threshold.

As an embodiment, the first sub-message and the second sub-message respectively include all or part of an IE (Information Element, information element) in an RRC signaling.

As an embodiment, the first sub-message and the second sub-message respectively include all or part of a field in an IE in an RRC signaling.

As an embodiment, the first message is received from the air interface.

As an embodiment, when the first message is received through a direct path, the first message is received through a PDSCH (Physical Downlink Shared CHannel) channel; when the first message is received through an indirect path, the first message is received through a PSSCH channel.

As an embodiment, the first expiration value is used to determine the expiration of the first timer.

As an embodiment, when the first timer is in a running state, the first timer is updated in a next time interval, and then it is determined whether the first timer has expired.

As an embodiment, the one time interval includes 1 millisecond.

As an embodiment, the one time interval includes a time length of one time slot.

As an embodiment, the one time interval includes a time length of 1 subframe.

As an embodiment, the value of the first timer is set to 0 when the first timer is started, and the phrase updating the first timer includes: adding 1 to the value of the first timer; when the value of the first timer is the first expiration value, the first timer expires.

As an embodiment, the first expiration value is used to determine the first PDCP The maximum residence time of the SDU in the first PDCP entity.

As an embodiment, the first expiration value is used to determine a remaining packet delay budget.

As an embodiment, in mode 2 resource allocation, the first expiration value is used for resource selection.

As a sub-embodiment of the above embodiment, the first expiration value is used to determine the duration indicated by the maximum value of the resource selection window.

As an embodiment, the difference between the first expiration value and the first threshold is used to determine the maximum transmission delay of the first PDCP PDU forwarded through the node where the opposite RLC entity of the second candidate RLC entity is located.

As an embodiment, the difference between the first expiration value and the first threshold is the maximum transmission delay of the first PDCP PDU forwarded through the node where the opposite RLC entity of the second candidate RLC entity is located.

As an embodiment, the difference between the first expiration value and the first threshold value is not less than the maximum transmission delay of the first PDCP PDU forwarded through the node where the opposite RLC entity of the second candidate RLC entity is located.

As an embodiment, the difference between the first expiration value and the first threshold is greater than the maximum transmission delay of the first PDCP PDU forwarded through the node where the opposite RLC entity of the second candidate RLC entity is located.

As an embodiment, the second node divides the transmission delay of the data unit of the first wireless bearer between the first node and the second node into the sum of two parts of the transmission delay, wherein the first part is the transmission delay between the first node and the third node, and the second part is the transmission delay between the third node and the second node, and the sum of the two parts of the transmission delay is not greater than the time length indicated by the first expiration value; the transmission delay between the first node and the third node is not greater than the time length indicated by the first threshold.

As an embodiment, the node where the opposite RLC entity of the second candidate RLC entity is located is the third node.

As an embodiment, the node where the opposite RLC entity of the second candidate RLC entity is located is a relay node.

As an embodiment, the node where the peer RLC entity of the second candidate RLC entity is located is layer 2 U 2 N relay UE.

As an embodiment, the expiration value of the first timer is the first expiration value.

As an embodiment, the expiration value of the second timer is the first threshold.

### Example 13

Embodiment 1 to 3 illustrates a structural block diagram of a processing device in a first node according to an embodiment of the present application, as shown in FIG. 1 to 3.

In FIG. 13, a first node processing device 1300 includes a first transceiver 1301. The first node 1300 is a UE.

In Example 13, a first transceiver 1301 receives a first PDCP SDU; starts a first timer as a response to receiving the first PDCP SDU; when the first timer is in a running state, delivers the first PDCP PDU to a first RLC entity for transmission; wherein the first PDCP PDU is a data unit after the first PDCP SDU is processed by the first PDCP entity; the first RLC entity is one of a first candidate RLC entity and a second candidate RLC entity, and whether the first RLC entity is the first candidate RLC entity or the second candidate RLC entity is related to the value of the first timer; the first candidate RLC entity and the second candidate RLC entity are respectively associated with the first PDCP entity; the data unit included in the first candidate RLC entity is sent via a direct path; the data unit included in the second candidate RLC entity is sent via a non-direct path.

As an embodiment, when the value of the first timer is greater than a first threshold, the first RLC entity is the first candidate RLC entity.

As an embodiment, when the value of the first timer is greater than a first threshold, the first RLC entity is the first candidate RLC entity; when the value of the first timer is less than the first threshold, whether the first RLC entity is the first candidate RLC entity or the second candidate RLC entity is related to the reference data amount; wherein, the reference data amount is the total amount of PDCP data in the first PDCP entity and the amount of RLC data waiting for initial transmission in the first candidate RLC entity and the second candidate RLC entity.

As an embodiment, when the value of the first timer is greater than a first threshold, the first RLC entity is the first candidate RLC entity; the first transceiver 1301 delivers the first PDCP PDU to the first candidate RLC entity for sending; wherein the value of the first timer is greater than the first threshold and the first timer has not expired; the first PDCP entity has not received an indication of successful sending of the first PDCP PDU from the second candidate RLC entity; the first RLC entity is the second candidate RLC entity.

As an embodiment, when the value of the first timer is greater than a first threshold, the first RLC entity is the first candidate RLC entity; the first transceiver 1301 delivers the first PDCP PDU to the first candidate RLC entity for sending; wherein the value of the first timer is greater than the first threshold and the first timer has not expired; the first PDCP entity has not received an indication of successful sending of the first PDCP PDU from the second candidate RLC entity; the first RLC entity is the second candidate RLC entity; the first transceiver 1301 sends a first indication, and the first indication is used to instruct the first RLC entity to discard the first PDCP PDU; when the first RLC SDU or the segment of the first RLC SDU has not been passed to a lower layer, the first RLC SDU is discarded; wherein the first RLC SDU is the first PDCP PDU.

As an embodiment, the direct path includes only one air interface, and the indirect path includes at least two air interfaces.

As an embodiment, the first transceiver 1301 receives a first message, wherein the first message indicates a first expiration value and the first threshold; wherein the first expiration value is used to determine the expiration of the first timer; and the difference between the first expiration value and the first threshold is used to determine the maximum transmission delay of the first PDCP PDU forwarded through the node where the opposite RLC entity of the second candidate RLC entity is located.

As an embodiment, the first transceiver 1301 includes the receiver 454 (including the antenna 452), the receiving processor 456, the multi-antenna receiving processor 458 and the controller/processor 459 in FIG. 4 of the present application.

As an embodiment, the first transceiver 1301 includes at least one of the receiver 454 (including the antenna 452), the receiving processor 456, the multi-antenna receiving processor 458 or the controller/processor 459 in FIG. 4 of the present application.

As an embodiment, the first transceiver 1301 includes the receiver 454 (including the antenna 452), the transmission processor 468, the multi-antenna transmission processor 457 and the controller/processor 459 in FIG. 4 of the present application.

As an embodiment, the first transceiver 1301 includes at least one of the receiver 454 (including the antenna 452), the transmit processor 468, the multi-antenna transmit processor 457 or the controller/processor 459 in FIG. 4 of the present application.

As an embodiment, the first transceiver 1301 includes the controller/processor 459 in FIG. 4 of the present application.

A person of ordinary skill in the art can understand that all or part of the steps in the above method can be completed by instructing the relevant hardware through a program, and the program can be stored in a computer-readable storage medium, such as a read-only memory, a hard disk or an optical disk. Optionally, all or part of the steps in the above embodiment can also be implemented using one or more integrated circuits. Accordingly, each module unit in the above embodiment can be implemented in the form of hardware or in the form of a software functional module. The present application is not limited to any specific form of combination of software and hardware. The first type of communication node or UE or terminal in the present application includes but is not limited to mobile phones, tablet computers, notebooks, Internet cards, low-power devices, eMTC (enhanced Machine Type Communication) devices, NB-IoT devices, vehicle-mounted communication equipment, aircraft, airplanes, drones, remote-controlled aircraft and other wireless communication devices. The second category of communication nodes or base stations or network-side devices in the present application include but are not limited to macrocell base stations, microcell base stations, home base stations, relay base stations, eNBs, gNBs, transmission and reception nodes TRP (Transmission and Reception Point), relay satellites, satellite base stations, aerial base stations, test equipment, such as transceivers that simulate some functions of base stations, signaling testers and other wireless communication equipment.

It should be understood by those skilled in the art that the present invention may be implemented in other specified forms without departing from its core or essential features. Therefore, the embodiments disclosed herein should be considered illustrative rather than restrictive in any way. The scope of the invention is determined by the appended claims rather than the preceding description, and all modifications within their equivalent meanings and regions are considered to be included therein.

1. A first node for wireless communication, comprising:
a first transceiver, configured to receive a first PDCP SDU; in response to receiving the first PDCP SDU, to start a first timer; and when the first timer is in a running state, to deliver the first PDCP PDU to a first RLC entity for sending; wherein:
the first PDCP PDU is a data unit processed by the first PDCP SDU through a first PDCP entity;
the first RLC entity is one of a first candidate RLC entity and a second candidate RLC entity, and whether the first RLC entity is the first candidate RLC entity or the second candidate RLC entity is related to a value of the first timer;
the first candidate RLC entity and the second candidate RLC entity are respectively associated with the first PDCP entity;
a data unit included in the first candidate RLC entity is sent by using a direct connection path; and
a data unit included in the second candidate RLC entity is sent through a non-direct connection path.

2. The first node according to claim 1, wherein when the value of the first timer is greater than a first threshold, the first RLC entity is the first candidate RLC entity.

3. The first node according to claim 2, wherein when the value of the first timer is less than the first threshold, the first RLC entity is the first candidate RLC entity or the second candidate RLC entity is related to a reference data volume; the reference data quantity is a total quantity of PDCP data quantity in the first PDCP entity and RLC data quantity waiting for initial transmission in the first candidate RLC entity and the second candidate RLC entity.

4. The first node according to claim 2, wherein:
the first transceiver delivers the first PDCP PDU to the first candidate RLC entity for sending;
the value of the first timer is greater than the first threshold and the first timer is not expired;
the first PDCP entity does not receive an indication that the first PDCP PDU is successfully sent from the second candidate RLC entity; and
the first RLC entity is the second candidate RLC entity.

5. The first node according to claim 4, wherein:
the first transceiver sends a first indication, where the first indication is used to indicate to the first RLC entity to discard the first PDCP PDU;
when none of the first RLC SDU or the segment of the first RLC SDU is transmitted to a bottom layer, the first RLC SDU is discarded; and
the first RLC SDU is the first PDCP PDU.

6. The first node according to claim 5, wherein the direct connection path includes only one air interface, and the non-direct connection path includes at least two air interfaces.

7. The first node according to claim 6, wherein
the first transceiver is further configured to receive a first message, where the first message indicates a first expiration value and the first threshold; and
the first expiration value is used to determine that the first timer expires, and a difference between the first expiration value minus the first threshold is used to determine a maximum transmission delay forwarded by the first PDCP PDU through a node where a peer RLC entity of the second candidate RLC entity is located.

8. A method in a first node for wireless communication, comprising:
receiving a first PDCP SDU;
starting a first timer as a response for receiving the first PDCP SDU; and
submitting the first PDCP PDU to a first RLC entity for sending when the first timer is in a running state; wherein:
the first PDCP PDU is a data unit processed by the first PDCP SDU through a first PDCP entity;
the first RLC entity is one of a first candidate RLC entity and a second candidate RLC entity, and whether the first RLC entity is the first candidate RLC entity or the second candidate RLC entity is related to a value of the first timer;
the first candidate RLC entity and the second candidate RLC entity are respectively associated with the first PDCP entity;
a data unit included in the first candidate RLC entity is sent by using a direct connection path; and
a data unit included in the second candidate RLC entity is sent through a non-direct connection path.

9. The method according to claim 8, wherein when the value of the first timer is greater than a first threshold, the first RLC entity is the first candidate RLC entity.

10. The method according to claim 9, wherein when the value of the first timer is less than the first threshold, the first RLC entity is the first candidate RLC entity or the second candidate RLC entity is related to a reference data volume; the reference data quantity is a total quantity of PDCP data quantity in the first PDCP entity and RLC data quantity waiting for initial transmission in the first candidate RLC entity and the second candidate RLC entity.

11. The method according to claim 9, wherein the method further comprises:
delivering the first PDCP PDU to the first candidate RLC entity for sending; and wherein:
the value of the first timer is greater than the first threshold and the first timer is not expired;
the first PDCP entity does not receive an indication that the first PDCP PDU is successfully sent from the second candidate RLC entity; and
the first RLC entity is the second candidate RLC entity.

12. The method according to claim 11, wherein the method further comprises:
sending a first indication, the first indication being used to indicate to the first RLC entity to discard the first PDCP PDU; and
discarding the first RLC SDU when none of the first RLC SDU or the segment of the first RLC SDU is transmitted to a bottom layer; wherein the first RLC SDU is the first PDCP PDU.

13. The method according to claim 12, wherein the direct connection path includes only one air interface, and the non-direct connection path includes at least two air interfaces.

14. The method according to claim 13, comprising:
receiving a first message, where the first message indicates a first expiration value and the first threshold; and wherein the first expiration value is used to determine that the first timer expires, and a difference between the first expiration value minus the first threshold is used to determine a maximum transmission delay forwarded by the first PDCP PDU through a node where a peer RLC entity of the second candidate RLC entity is located.
